(19) United States
(12) Patent Application Publication
(10) Pub. No.: US 2009/0007453 A1
(43) Pub. Date: Jan. 8, 2009

(54) Flame Dryer

(75) Inventors: Jean-Pierre Robin, Roncq (FR); Patrick Lenoir, Villeneuve d'Ascq (FR)

Correspondence Address: FOLEY AND LARDNER LLP;SUITE 500, 3000 K STREET NW, WASHINGTON, DC, 20007, US

(73) Assignees: NV Bekaert SA; Bekaert Combustion Technology BV

(21) Appl. No.: 12/161,904

(22) PCT Filed: Jan. 24, 2007
(86) PCT No.: PCT/EP07/50692

§ 371 Date: Jul. 23, 2008

(30) Foreign Application Priority Data
Jan. 25, 2006 (EP) 06100857.9
Jan. 31, 2006 (EP) 06101071.6

(51) Int. Cl. F26B 13/00

(52) U.S. Cl. 34/611

(57) ABSTRACT

The object of the invention is an dryer in the dryer section (26) of a machine for treating or producing a web (12). This drying section (26) has, amongst other things, a burner assembly (10), wherein this burner assembly (10) is adapted to produce a flame (14) and exhaust gases (18). Either said flame (14) or the exhaust gases (18) or both are in direct contact with the web (12) to be dried. The flame (14) or the exhaust gases (18) or both cover the maximum width of the web (12) to be dried and this at a temperature exceeding 600° C., e.g. above 700° C., e.g. 800° C., preferably 1000° C. and more. By applying such a high temperature to the web (12) to be dried, one achieves a large temperature difference, resulting in a better heat transfer Considering the theoretical equation of heat transfer qₓ=kₓ. Aₓ.DTₓ, it is evident that because of the large temperature difference, the dimensions of the system can be reduced and/or the efficiency of the drying process can be refined. A further advantage of the higher energy transfer is that the drying process is accelerated and that the web can pass the dryer at high speeds.

### TECHNICAL FIELD

The present invention relates to a drying section of a machine for treating or producing a material web such as paper, and more particular to airborne drying sections of such machines.

### BACKGROUND ART

Machines for drying material web such as paper may comprise a number of mutually different sections for drying the material of the web. The technology of drying the web is usually IR-drying, contact drying using heated rotating drums, or drying by means of heated air in airborne drying sections.

An airborne drying section of a machine for producing a material web such as paper, and more particular to airborne drying sections of such machines is known e.g. from U.S. Pat. No. 6,598,315 or US2001/0042316.

The disadvantages of such presently known airborne drying sections are multiple. The heating source, providing hot gas is usually a relatively large and robust gas burning device, which provides exhaust gas to a duct system, in which the exhaust gas is diluted by huge amount of colder air, prior to feeding this diluted exhaust gas to nozzle bars, directing the diluted exhaust gas to the web surface.

This has the disadvantage that the temperature of the drying air is relatively low, the amount of air to be compressed and moved through the nozzles is large and requires large ventilators, and due to the lower temperature, the efficiency of the system is relatively low. Additionally, the system requires significant space due to the size of the required burners and ducting systems, and is relatively inflexible due to the large thermal mass of the heated air. The latter results in significant energy loss as the burner is usually not turned off in case of e.g. web ruptures.

### SUMMARY OF THE INVENTION

It is an object of the present invention to provide a drying section of a machine for producing a material web which solves the problems of the present prior art. It is an object of the present invention to provide a drying section of a machine for producing a material web which has an increased yield. It is an object of the present invention to provide a drying section of a machine for producing a material web which has improved flexibility. It is an object of the present invention to provide a drying section of a machine for producing a material web which is smaller in size and can be used in any direction. It is an object of the present invention to provide a drying section of a machine for producing a material web which is able to use smaller ventilators and which is limited in size and number of parts. It is an object of the present invention to provide a drying section of a machine for producing a material web which has a limited and simplified ducting system. It is an object of the present invention to provide a drying section of a machine for producing a material web which has above mentioned improvements and which is part of a paper drying machine. It is an object of the present invention to provide a drying section of a machine for producing a material web which has above mentioned improvements and which is part of an airborne drying machine.

According to a first aspect of the invention, there is provided a drying section of a machine for treating or producing a web. This drying section has, amongst other things, a burner assembly, wherein this burner assembly is adapted to produce a flame and exhaust gases. Ether said flame or the exhaust gases or both are in direct contact with the web to be dried. The flame or the exhaust gases or both cover the maximum width of the web to be dried and this at a temperature exceeding 600° C., e.g. above 700° C., e.g. 800° C., preferably 1000° C. and more. By applying such a high temperature to the web to be dried, one achieves a large temperature difference, resulting in a better heat transfer. Considering the theoretical equation of heat transfer qₓ=kₓ. Aₓ.DTₓ, it is evident that because of the large temperature difference, the dimensions of the system can be reduced and/or the efficiency of the drying process can be refined. A further advantage of the higher energy transfer is that the drying process is accelerated and that the web can pass the dryer at high speeds.

A preferable embodiment of the invention provides a burner assembly wherein the burner membrane of the burners is a metal fiber membrane. In a more preferred embodiment the burner membrane is a knitted mete fiber membrane, e.g. the FURINIT® burner of the applicant, which is described in more detail in WO 2004/092647. The burner assembly is adapted for burning in blue flame mode, but can also burn in radiant mode. The burner assembly can be only one burner element or a group of burners.

Another preferred embodiment of the invention provides a burner assembly which is a modular system. By modular it is meant that the burner assembly can be a group of burner elements which can be put together in different ways, which will be further illustrated in the figures.

Those burner elements can be controlled simultaneously or on individual basis. Another preferred embodiment of the invention provides a drying section wherein the distance of the web to the burner membrane is 10 cm or less.

A further aspect of the invention is the drying section wherein, next to the burner assembly, there is also at least one blowing nozzle. These nozzles can be put before and/or after the burner assembly. These nozzles cover the maximum width of the web to be dried.

In order to further increase the yield of use of thermal energy during the drying of the web, in a preferred embodiment of the invention a nozzle is foreseen prior to the first web guiding device, which nozzle blows air in the opposite direction of the web travelling direction, on the web surface, either to one side but preferably to both sides, and in any case to the surface of the web to be dried. Such nozzle, hereafter referred to as a “coanda like nozzle”, prevents to a large extent that the web drags a cold air layer into the drying section, which layer of air creates an insulating barrier between the hot air of the drying section and the web, preventing a good heat transfer between hot air and web.

A further preferred embodiment of the invention provides a drying section wherein the exhaust gas is collected and re-used for further drying of the web. The collected exhaust gases will then be blown on the web by blowing nozzles accommodated to blow those hot combustion gasses, such systems are already described in the art, e.g. FR-A-2771161 or WO 2005/085729.

According to a further aspect of the invention, the system of re-using the exhaust gases is a convective system. This convective system is an assembly of an exterior casing for suction of combustion products with opening towards the web, with a first and second suction ducts sucking the combustion products into the convective system. The combustion products coming from the first suction duct are guided through the exterior casing to a mixing and blowing device. Cold air is mixed in this mixing and blowing device with the combustion products, resulting in a gas mixture with lower temperature.

The convective system also has an internal casing inside the external casing. This internal casing has at least one opening towards the web and has also openings allowing gas flow from the external casing to the internal casing of said gas mixture. Under the internal casing, there is also a blowing duct.

The second suction duct is also arranged under this internal casing thereby extracting a second flow of combustion products into the internal casing. This second flow of combustion products is then mixed with the gas mixture with lower temperature coming from the mixing device, resulting in a mixture of gasses with a temperature that is higher than the first gas mixture and higher than e.g. 350° C., more preferably 400° C. or 450° C., even more preferably 500° C. These hot gasses are then blown to the drying web by the blowing duct of the internal casing.

Also according to the invention this improved convective system can be achieved by simple means, by applying an inner casing into the outer casing. It is clear that applying an inner casing can be done without difficulties, thus in a simple way. Applying an inner casing can be realized both in a completely new convective system and in an existing convective system without changing drastically the dimensions.

This direct reuse of hot combustion products in the internal casing increases the temperature of the blown gasses resulting in a more efficient use of the heat produced by the dryer system and improving the efficiency of the heat exchange in the system.

According to another version of the invention, the convective system is designed in such a way that the blowing duct is arranged between said first suction duct and said second suction duct.

A preferable embodiment of the invention provides a special design of the internal casing resulting in a good air distribution.

Another preferred embodiment of the invention provides in the system an air pressure sensor in order to assure constant flotation effect on the web to be dried. A temperature sensor can also be foreseen.

A preferred embodiment of the invention is the convective system wherein the mixing and blowing device at least has one turbine of which the axis is perpendicular to the web. Another version of the invention is the convective system wherein the mixing and blowing device at least has one turbine of which the axis is parallel to the web.

According to a further aspect, the invention provides a method for safeguarding a fan from contact with hot combustion gasses by using above described convective system.

According to a further aspect, the invention provides a method of re-using heated gasses to enhance the heat exchanging efficiency using the above described convective system.

In an even more preferred embodiment of the invention the system of re-using the exhaust gases is a cascade system, wherein the exhaust gases coming directly from the burner assembly are sucked by a suction unit whereafter these hot gasses are blown to the web by a blowing system. The warm gasses which are then available at the second nozzle can again be sucked for re-use and re-blown thereby making further use of the available thermal energy which was created by the burner assembly. For example, first there is the burner assembly with temperatures over 1000° C., thereafter a first blowing section which blows re-used exhaust gasses at 400° C. and thereafter a second blowing section which blows gasses at 200° C.

This further increases the drying efficiency of the system.

Another preferred embodiment of the invention is the drying section wherein the burner assembly is enclosed at all sides apart from the flame side by an insulator which protects the mete parts of the suction and blowing sections against the very high temperatures coming from the burner assembly and which protects the flame from air turbulences coming from the blowing nozzles.

A further aspect of the invention provides a dryer installation wherein such a drying section is present. In a preferred embodiment, such a dryer installation has at least two drying sections arranged one after the other in the passing direction of the web and separated one from the other by at least one air blowing nozzle. In another preferred embodiment the dryer installation has at least one drying section at the front and the back side of the web to be dried.

Another aspect of the invention provides a drying section of a machine for treating or producing a material web which may be used for paper or cardboard production or for drying coatings on webs such as paper or cardboard.

### BRIEF DESCRIPTION OF DRAWINGS

FIGS. 1a, 1b and 1c: schematic view of three different embodiments of a drying section according to the invention

FIGS. 2a, 2b and 2c: show different configurations of a burner assembly in the invention

FIG. 3: cross-section of a drying section

FIG. 4: embodiment of a drier installation

FIG. 5: embodiment of a drier installation

FIG. 6: schematic representation of drying section with re-use of exhaust gas energy

FIG. 7: schematic representation of drying section with another system for re-use of exhaust gas energy

### REFERENCE LIST OF USED NUMBERS IN THE FIGURES

10 burner assembly
12 web
14 flame
16 passing direction of the web
18 exhaust gases
20 mete fiber burner element
22 coanda like nozzle
24 blowing nozzle
26 drying section
28 insulation piece
107 convective system
109 devices to extract the warm gasses resulting from the convective thermal exchanges, arrow
113 exterior casing
114 opening towards the web
115 first suction duct
116 second suction duct
117 a mixing and blowing device
118 fresh cold air
119 combustion products
120 gas mixture with lower temperature 20
121 internal casing
122 opening in internal casing towards the web
123 blowing duct
124 a second flow of combustion products
125 mixture of gasses with t° higher than from (20)
126 extraction duct
130 turbine
132 suction opening of turbine
133 tangential outlet opening of turbine
134 openings allowing gas flow from the mixing device 17 to the internal casing

### DESCRIPTION OF THE PREFERRED EMBODIMENTS OF THE INVENTION

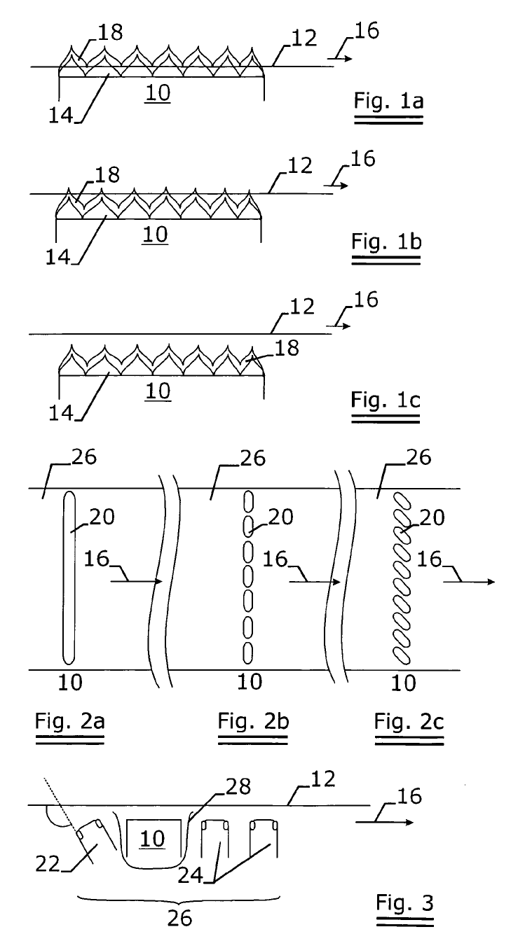

FIG. 1 represents a schematic view of the three different positions the metal fiber burner assembly can have in relation to the passing web. In FIG. 1a the web 12 passes through the flame 14 of the burner assembly 10. In FIG. 1b the web 12 passes through the tip of the flame 14. In FIG. 1c the web passes through the exhaust gases 18.

In any of the positions as depicted in FIG. 1, the web will pass a temperature zone of more than 600° C., preferably more than 700°, and higher, depending on the distance of the web to the burner assembly. Temperatures of 1500° C. and higher can thus be reached locally.

By applying such a high temperature to the web to be dried, one achieves a large temperature difference, resulting in a better heat transfer.

Considering the theoretical equation of heat transfer qₓ=kₓ. Aₓ.DTₓ, it is evident that because of the large temperature difference, the dimensions of the system can be reduced and/or the efficiency of the drying process can be refined.

A further advantage of the higher energy transfer is that the drying process is accelerated and that the web can pass the dryer at high speeds. The speed of the web 12 may range typically between 50 m/min and 2000 m/min or even more, e.g. 100 m/min, 300 m/min, 500 m/min, 700 m/min, 900 m/min, 1100 m/min, 1300 m/min, 1500 m/min, 1700 m/min, 1900 m/min, 2100 m/min.

In prior art drying equipment, the speed of the web is limited because of the drying section. Higher speeds require large drying sections.

In big contrast herewith the drying section 26 of the invention provides an efficient drying of the web 12 so that higher speeds are allowed and even desired without requiring large drying units.

This can be done for web widths up to 11 m or even higher, e.g. up to 9 m.

The distance between the web 12 and the burner assembly 10 is preferably 10 cm or less, e.g. 10 cm; 9 cm; 8 cm; 7 cm; 6 cm; 5 cm; 4 cm; 3 cm; 2 cm; 1 cm or 0.5 cm.

In a further embodiment of the invention sophisticated high speed controls read the moisture content across the paper sheet and adjust the burner assembly 10 temperature accordingly in commonly used profiling-processes.

FIG. 2 represents the different possible set-ups of the burner assembly in the drying section.

FIG. 2a shows one mete fiber burner element 20 covering the whole width of the web 12. FIG. 2b shows an assembly 10 of smaller mete fiber burner elements 20 one after the other, perpendicular on the web moving direction 16 and the assembly 10 covering the whole width of the web 12. FIG. 2c shows another assembly of smaller metal fiber burner elements 20, arranged parallel to each other, but with an angle in relation to the web moving direction 16 and the assembly 10 covering the whole width of the web 12. The assemblies are a group of smaller burner elements and can be controlled simultaneously or on individual basis. When the burner elements are controlled individually, a more homogenous temperature can be obtained over the whole web width. As the center of the dryer system will have less heat loss, hence less heat should be generated there. The control of those burner elements on an individual basis thus makes the system more easily controllable and increases the energy efficiency of the complete dryer section.

FIG. 3 shows one embodiment of the invention. The metal fiber burner assembly 10 is combined with a coanda like nozzle 22 which blows air in the opposite direction of the web travelling direction, on the web surface, either to one side but preferably to both sides, and in any case to the surface of the web to be dried. This nozzle 22 is therefore put in an obtuse angle (a>90°) with respect to the entering web 12. The nozzle 22 thereby prevents that the web 12 drags a cold air layer into the drying section 26. The coanda like nozzle 22 and burner assembly 10 are further combined with blowing nozzles 24 which blow hot gases to the web 12 to be dried. The burner assembly 26 is enclosed on all sides apart from the flame side by an insulator piece 28 which protects the metal parts of the suction and blowing sections 24 against the very high temperatures coming from the burner assembly 10 and which protects the flame 14 from air turbulences which might be caused by the blowing nozzles 24. The insulator piece 28 can be made of any commercially available insulation material, e.g. a ceramic insulation material in the form of a pliable plate.

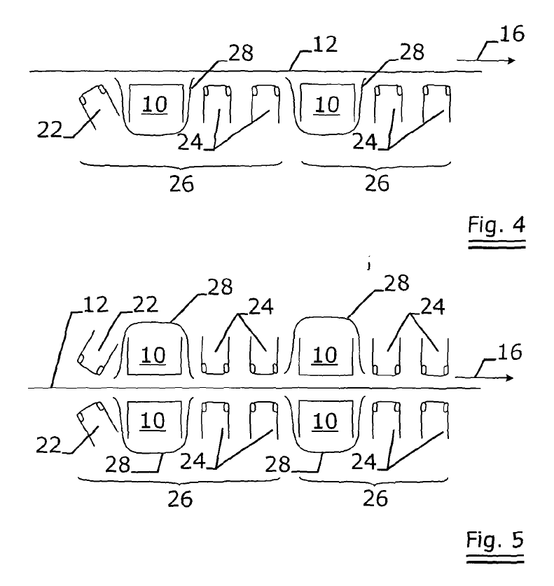

As schematized in FIG. 4 one can foresee at least two dryer sections 26 according to the present invention, arranged one after the other in the passing direction 16 of the web 12, in a drier installation.

According to the drier installation of FIG. 5, at least one drying section 26 can be placed at the front side together with a drying section 26 at the back side of the web 12 to be dried.

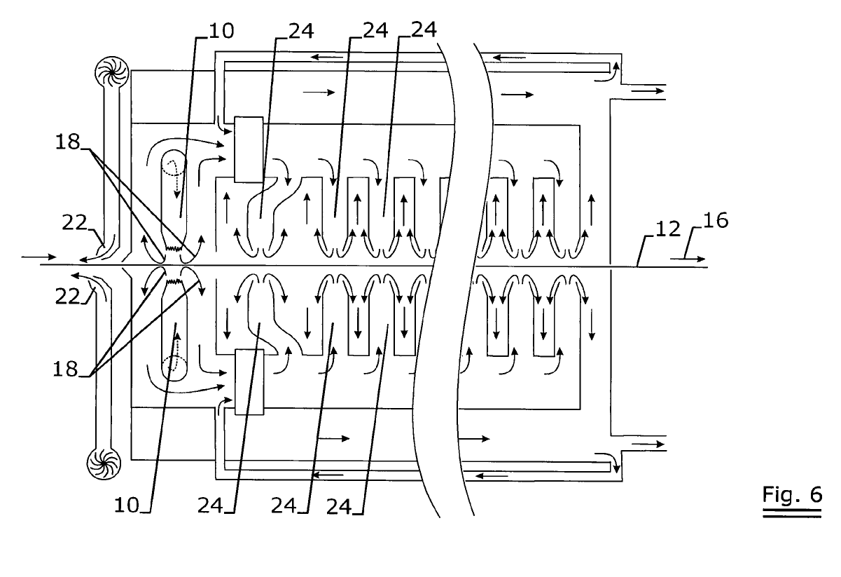

FIG. 6 represents one principle of re-use of exhaust gases in the drying section. The exhaust gases 18 produced by the burner assembly 10 are sucked from the system in any conventional way and these hot exhaust gases are then blown on the web 12 via the nozzles 24 in order to further dry the web 12. By re-using these hot gases the energy efficiency of the system 26 is further increased and the drying process is further enhanced because of the moisture regulating activity of the semi-wet hot gases. The system of recirculating the hot gases can be done in any way known already in the art, e.g. FR-A-2771161 or WO 2005/085729 in the name of the applicant.

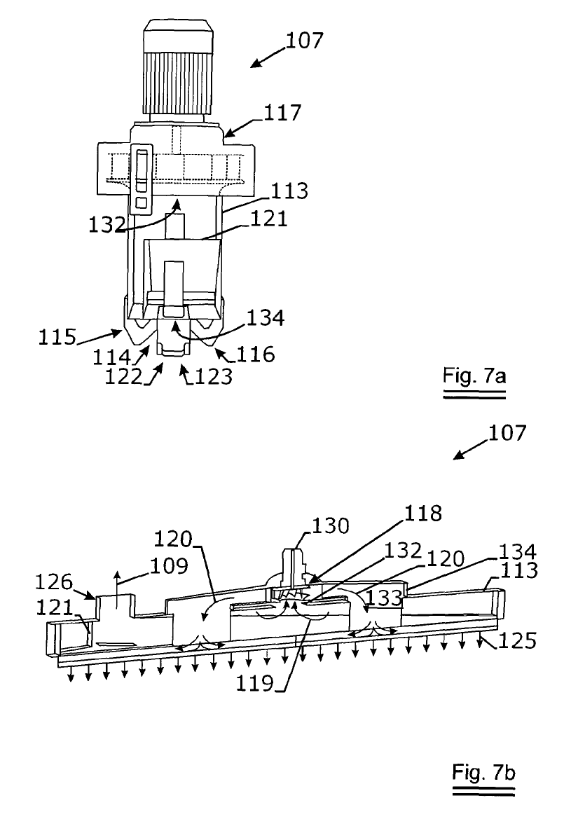

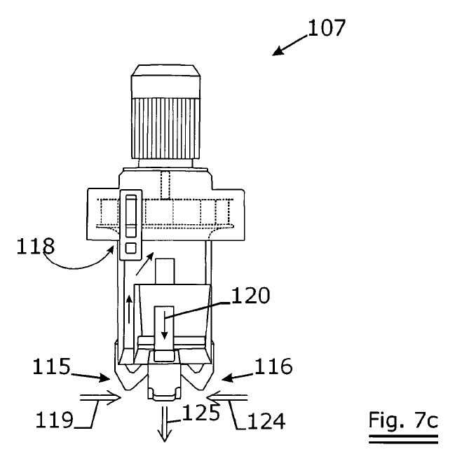

Another system for the re-use of exhaust gases is shown in FIGS. 7A, 7B and 7C. The convective system 107 is an assembly of an exterior casing 113 for suction of combustion products with opening 114 towards the web, with a first 115 and second 116 suction ducts sucking the combustion products into the convective system 107. The combustion products coming from the first suction duct 115 are guided through the exterior casing 113 to a mixing and blowing device 117. Cold air 118 is mixed in this mixing and blowing device 117 with the combustion products 119, resulting in a gas mixture with lower temperature 120.

The convective system 107 also has an internal casing 121 inside the external casing 113. This internal casing 121 has at least one opening towards the web 122 and has also openings 134 allowing gas flow from the mixing device 117 to the internal casing 121 of said gas mixture 120.

Under the internal casing 121, there is also a blowing duct 123.

The second suction duct 116 is also arranged under this internal casing 121 thereby extracting a second flow of combustion products 24 into the internal casing 121. This second flow 124 of combustion products is then mixed with the gas mixture 120 coming from the mixing device 117, resulting in a mixture of gasses 125 with a temperature that is higher than the first gas mixture 120 and higher than e.g. 350° C. or 370° C., more preferably 390° C. or 410° C., even more preferably 420° C., 450° C. or 500° C. These hot gasses 125 are then blown to the drying web by the blowing duct 123 of the internal casing 121.

FIG. 7B is a cross-section, according to a plane perpendicular to the web 12 that stretches out in the transversal direction of the web (according to A-A′), of the convective system 107. The suction ducts 115 and 116 and blowing duct 123 stretch out over the total web width, but are not indicated in this figure. In order to achieve a good three-dimensional air distribution in the inner duct 121, the convective system 107 can preferably be designed as indicated in FIG. 7B. The internal casing 121 comprises also an extraction duct 126 that is part of the devices 109. The extraction duct 126 extracts part of the warm gasses 125 and part of the combustion gasses 119. This extraction duct 126 is asymmetrically arranged in the convective system 107. In order to obtain a good air blowing distribution, the inner height of the internal casing 121 is also asymmetric and increases towards the extraction duct 126.

The devices 109 are known extraction devices, e.g. a fan.

In the represented example, each turbine 130 has a centrifuge turbine wheel of which the suction opening 132 is connected to an upstream transversal suction duct 115 in relation to the web 102. The wheel is driven by an engine, as in any conventional fan.

The mixed gasses 120 are blown through two tangential outlet openings 133 substantially directly opposite to the transversal direction of the web 12, and connected to two transversal blowing ducts 134.

In an even more preferred embodiment of the invention the system of re-using the exhaust gases is a cascade system, wherein the exhaust gases coming directly from the burner assembly are sucked by a suction unit or a convective system whereafter these hot gasses are blown to the web by a blowing system or the blowing duct from the convective system. The warm gasses which are then available at the second nozzle or convective system can again be sucked for re-use and re-blown thereby making further use of the available thermal energy which was created by the burner assembly. For example, first there is the burner assembly with temperatures over 1000° C., thereafter a first blowing section which blows re-used exhaust gasses at 400° C. and thereafter a second blowing section which blows gasses at 200° C.

We have thus described and represented a drying section for use in a drier installation designed and arranged to limit as much as possible thermal losses in order to maintain the high energy potential of the combustion products and thus allow an excellent return of the convective thermad exchanges between the web and the sucked and blown combustion products.

Obviously, the devices of the invention described above are designed and arranged in any suitable way so that they can endure durably and reliably the high temperatures of the sucked and/or blown combustion products.

In addition to the important improvement of the thermal exchanges between the combustion products and the web, the devices of the invention described above can be used in any possible direction, resulting in an improved flexibility for implementation in the production line of a material web, without being a limiting factor of the production speed.

In any way, the system can be used every time you need to evaporate water from a moving web.

1. A drying section of a machine for treating or producing a web, said drying section comprising a burner assembly said burner assembly adapted to produce a flame and exhaust gases wherein either said flame or said exhaust gases or both directly cover the maximum width of said web at a temperature exceeding 600° C. when in use, said burner assembly further comprising a burner membrane, said burner membrane being part of said burner element, wherein said burner membrane is a metal fiber membrane.

2. A drying section according to claim 1, wherein the distance of the web to the burner membrane is 10 cm or less.

3. A drying section according to claim 1, wherein said burner assembly is adapted for burning in blue flame mode.

4. A drying section according to claim 1, wherein said burner assembly comprises different modules.

5. A drying section of a machine as in claim 1, wherein said burner assembly comprises a number of combustion burners side by side in the transversal direction of said web, said number being equal to or larger than one.

6. A drying section of a machine as in claim 1, wherein said burner assembly comprises a number of blue flame combustion burners side by side in the longitudinal direction of said web, said number being equal to or larger than one.

7. A drying section of a machine as in claim 5, wherein the amount of combustible gas being provided to each of said burners is adjustable for each of said burners in the burner assembly separately.

8. A drying section of a machine as in claim 5, wherein the amount of combustible gas provided to each of said burners is adjustable for all of them together.

9. A drying section according to claim 1, further comprising at least one air blowing nozzle before and/or after said burner assembly, said air blowing nozzles covering the maximum web width.

10. A drying section according to claim 1, comprising at the entrance of the drying section a blowing nozzle for preventing the formation of a cold-air insulating layer on the web to be dried, said blowing nozzle covering the maximum width of said web.

11. A drying section according to claim 10, wherein the blow direction of said blowing nozzle is in the opposite direction of the web moving direction.

12. A drying section of a machine according to claim 1, wherein said drying section comprises means for collecting said exhaust gas and re-use of said hot exhaust gases for drying of said web being blown by blowing nozzles accommodated to blow said collected exhaust gas to said web.

13. A drying section of a machine according to claim 1, wherein said drying section further comprises a convective system for collecting said exhaust gas and re-use of said hot exhaust gases for drying of said web, said convective system arranged transversally with respect to a web to be dried, said convective system comprising
an exterior casing for suction of combustion products with opening towards the web
a first and second suction ducts and sucking said combustion products into said convective system
said first suction duct sucking said combustion products into said exterior casing
a mixing and blowing device for re-use of said combustion products, thereby mixing cold air with said combustion products resulting in a gas mixture with lower temperature
an internal casing inside said external casing with at least one opening towards the web
said internal casing having openings allowing gas flow from external casing to internal casing of said gas mixture
a blowing duct under said internal casing wherein
said second suction duct is also arranged under said internal casing
said second suction duct extracting a second flow of combustion products into said internal casing
said second flow of combustion products consequently being mixed with said gas mixture with lower temperature resulting in a mixture of gasses with a temperature that is higher than said first gas mixture
said resulting mixture of gasses being blown to the drying web by said blowing duct.

14. A drying section of a machine according to claim 12, wherein said re-use of exhaust gasses is in a cascade.

15. Dryer installation comprising a drying section according to claim 1, wherein said installation comprises at least two drying sections arranged one after the other in the passing direction of the web and separated one from the other by at least one air blowing nozzle.

16. A dryer installation comprising a drying section according to claim 1, wherein said installation comprises at least one drying section at each side of said web.
